(19) United States
(12) Patent Application Publication
(10) Pub. No.: US 2013/0323541 A1
(43) Pub. Date: Dec. 5, 2013

(54) AIR ELECTRODE FOR AIR BATTERY, METHOD OF PRODUCING SAME, AND AIR BATTERY

(71) Applicants: Fuminori Mizuno, Susono-shi (JP); Kota Washio, Suntou-gun (JP); Noritsugu Sakuma, Susono-shi (JP)

(72) Inventors: Fuminori Mizuno, Susono-shi (JP); Kota Washio, Suntou-gun (JP); Noritsugu Sakuma, Susono-shi (JP)

(73) Assignee: TOYOTA JIDOSHA KABUSHIKI KAISHA, Toyota-shi, Aichi-ken (JP)

(21) Appl. No.: 13/984,685

(22) PCT Filed: Feb. 16, 2012
(86) PCT No.: PCT/IB2012/000281

§ 371 Date: Aug. 9, 2013

(30) Foreign Application Priority Data
Feb. 24, 2011 (JP) 2011-038683

(51) Int. Cl. H01M 4/86

(52) U.S. Cl. CPC H01M 4/8663
USPC 429/10; 429/535

(57) ABSTRACT

An air electrode for an air battery is provided constituting an air battery that is provided with an air electrode, a negative electrode, and an electrolyte interposed between the air electrode and the negative electrode, and containing the air electrode contains a magnet, and also an air battery having this air electrode is provided. A method of producing an air electrode for an air battery is provided constituting an air battery that is provided with an air electrode, a negative electrode, and an electrolyte interposed between the air electrode and the negative electrode, wherein a magnetization treatment is performed on an air electrode molding provided by molding an air electrode material that contains at least a magnet material.

### BACKGROUND OF THE INVENTION

1. Field of the Invention

The invention relates to an air electrode for an air battery, a method of producing this air electrode, and an air battery that is provided with this air electrode.

2. Description of the Related Art

Air batteries, which use oxygen as their positive electrode active material, offer the advantages, inter alia, of a high energy density, ease of downsizing, and ease of weight reduction. As a consequence, air batteries are receiving attention at the present time as high-capacity batteries that surpass the lithium secondary batteries now in widespread use. Available air batteries include, for example, metal-air batteries such as lithium-air batteries, magnesium-air batteries, and zinc-air batteries. Metal-air batteries are capable of charge/discharge cycling by carrying out the oxidation-reduction reactions of oxygen at the air electrode and at the negative electrode carrying out the oxidation-reduction reactions of a metal present in the negative electrode. For example, the charge/discharge reactions are believed to proceed as given below in the case of a metal-air battery (secondary battery) in which the carrier ion is a monovalent metal ion. M in the following equations indicates a metal species.

[During discharge]

negative electrode:M→M⁺+e⁻

positive electrode:2M⁺+O₂+2e⁻→M₂O₂

[During charging]

negative electrode:M⁺+e⁻→M

positive electrode:M₂O₂→2M⁺+O₂+2e⁻

Metal-air batteries have, for example, an air electrode layer that contains an electroconductive material and a binder; an air electrode current collector, which performs current collection for the air electrode layer; a negative electrode layer that contains a negative electrode active material, e.g., a metal or alloy; a negative electrode current collector, which performs current collection for the negative electrode; and an electrolyte interposed between the air electrode layer and the negative electrode layer. A catalyst is added to the air electrode in order to accelerate the electrode reactions at the air electrode during discharge and/or charging and thereby improve the battery characteristics (for example, Japanese Patent Application Publication No. 2006-286414 (JP-A-2006-286414) and Japanese Patent Application Publication No. 2010-108622 (JP-A-2010-108622)). Specifically, JP-A-2006-286414 discloses a layer that has an oxygen reducing capacity; this layer contains a carbonaceous material, a catalyst supported on the surface of this carbonaceous material, and a binder. The use of, for example, manganese oxide, lanthanum strontium cobalt oxide, and so forth, for this catalyst is described in JP-A-2006-286414.

As in the art described above, improvements in the charge/discharge characteristics can be pursued by incorporating a catalyst in the air electrode. However, the discharge capacity and/or charge capacity must be increased still further in order to realize the higher energy density potential of air batteries.

### SUMMARY OF THE INVENTION

The invention provides an air battery and an air electrode that can realize a higher energy density for air batteries by increasing the active sites of the catalyst added to the air electrode in order to thereby fully engage its catalytic capacity.

A first aspect of the invention relates to an air electrode for an air battery. This air electrode for an air battery is an air electrode constituting an air battery that is provided with an air electrode, a negative electrode, and an electrolyte interposed between the air electrode and the negative electrode, and this air electrode contains a magnet. According to this aspect, the oxygen concentration (activity) at the air electrode is increased due to the incorporation of the magnet. As a result, the reaction at the air electrode during discharge can be accelerated and the discharge capacity can be increased.

The magnet may be, for example, a hard magnetic material. NdFeB-type magnets are a specific example of this hard magnetic material. When a NdFeB-type magnet is used as this magnet, the air electrode may contain from at least 10% by weight to not more than 60% by weight of the NdFeB-type magnet.

A second aspect of the invention relates to an air battery. This air battery is provided with an air electrode, a negative electrode, and an electrolyte interposed between the air electrode and the negative electrode, and is provided with the air electrode according to the preceding aspect. Because it is provided with the air electrode according to the preceding aspect, the air battery according to this second aspect exhibits a high discharge capacity.

A third aspect of the invention relates to a method of producing an air electrode for an air battery. In this aspect, which is a method of producing an air electrode constituting an air battery that is provided with an air electrode, a negative electrode, and an electrolyte interposed between the air electrode and the negative electrode, a magnetization treatment is performed on an air electrode molding provided by molding an air electrode material that contains at least a magnet material. The method according to this aspect of producing an air electrode for an air battery enables facile adjustment of the conditions for subjecting the magnetic material to the magnetization treatment and thus exhibits an excellent productivity.

According to the aforementioned aspects, the oxygen concentration at the air electrode can be raised and the catalytic capacity of the catalyst added to the air electrode can be fully engaged, thereby making it possible to realize a higher energy density for the air battery.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional diagram that shows an exemplary embodiment of the invention;

FIG. 2 describes the air electrode (air electrode layer) production processes A, B, and C of the examples and comparative examples;

FIG. 3 is a graph showing the relationship between the discharge capacity and discharge voltage for the examples and comparative examples; and

FIG. 4 is a graph showing the relationship between the discharge capacity and discharge voltage for the examples and comparative examples.

### DETAILED DESCRIPTION OF EMBODIMENTS

The air electrode of the invention for an air battery is an air electrode that is a constituent of an air battery that is provided with an air electrode, a negative electrode, and an electrolyte interposed between the air electrode and the negative electrode, and is characterized in that it contains a magnet.

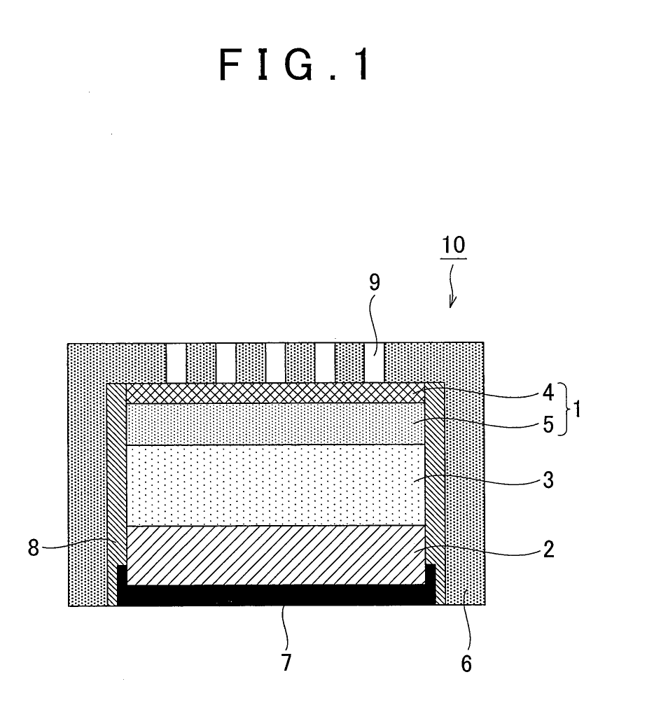

The air electrode of the invention for an air battery and the air battery of the invention are described below with reference to the figures. In the air battery 10 shown in FIG. 1, an air electrode (positive electrode) 1 and a negative electrode 2 are held in a battery case composed of an air electrode can 6 and a negative electrode can 7. The air electrode 1 and the negative electrode 2 are layered with an electrolyte 3 interposed between the air electrode 1 and the negative electrode 2. The air electrode can 6 and the negative electrode can 7 are fixed by a gasket 8 and a seal is thereby maintained within the battery case.

The air electrode 1 in FIG. 1 is composed of an air electrode layer 5 and an air electrode current collector 4 that carries out current collection for the air electrode layer 5. The air electrode layer 5 is the location of the oxidation-reduction reactions of oxygen and is formed from an air electrode material that contains a magnet, an electroconductive material (for example, carbon black), and a binder (for example, polytetrafluoroethylene). The air electrode current collector 4 is composed of an electroconductive material that has a porous structure (e.g., a metal mesh), and the air taken in through an air hole 9 disposed in the air electrode can 6 is then supplied through the air electrode current collector 4 to the air electrode layer 5.

The negative electrode 2 contains a negative electrode active material (for example, Li metal) capable of releasing and incorporating the metal ion that is the carrier ion species.

The electrolyte 3 contains an electrolyte solution provided by dissolving a supporting electrolyte salt (for example, lithium bis(trifluoromethanesulfonyl)amide) in a nonaqueous medium (for example, N-methyl-N-propylpiperidinium bis(trifluoromethanesulfonyl)amide); this electrolyte solution is impregnated into a separator (not shown) composed of an insulating porous body disposed between the air electrode 1 and the negative electrode 2.

As a result of intensive investigations by the inventors, it was discovered that the discharge capacity of an air battery can be improved by the use of a magnet (magnetic material) as a material constituting the air electrode. It is believed that this occurs because oxygen (oxygen gas), the active material at the air electrode, exhibits paramagnetism and oxygen is therefore readily incorporated by the magnet-containing air electrode, resulting in an increase in the oxygen concentration (activity). As a result of the increase in the oxygen concentration at the air electrode, the catalytic function is very efficiently manifested at the air electrode during discharge and the electrode reactions, e.g., precipitation of the metal oxide (or metal hydroxide), are accelerated and the discharge capacity of the air battery is increased. In addition, this increase in the oxygen concentration at the air electrode is thought to also result in a decline in the overvoltage for oxygen reduction and thus an increase in the discharge voltage of the air battery.

The air battery in this embodiment uses oxygen as its positive electrode active material but is not otherwise particularly limited, and it may be a primary battery or a secondary battery. The air battery can be specifically exemplified by metal-air batteries such as lithium-air batteries, sodium-air batteries, potassium-air batteries, magnesium-air batteries, calcium-air batteries, zinc-air batteries, aluminum-air batteries, and so forth.

Each constituent in the air electrode for air batteries of this embodiment and in the air battery of this embodiment is more particularly described in the following. The air electrode will be described first. The air electrode is generally provided with an air electrode layer that contains a magnet and an electroconductive material in addition to the magnet. At the air electrode layer, the supplied oxygen reacts with the metal ion to produce the metal oxide or metal hydroxide at the surface of the electroconductive material. The air electrode layer ordinarily has a porous structure in order to maintain the diffusivity of the oxygen that is the active material.

There are no particular limitations on the magnet, and the magnet may be a soft magnetic material or a hard magnetic material; however, a hard magnetic material is preferred from the standpoint of exhibiting a stable magnetism and achieving a long-term manifestation of the effects of this embodiment as described above. Soft magnetic materials can be exemplified by Fe₂O₃, soft iron, spinel ferrite, and AFe₂O₄ (A=Mn, Ni, CuZn, and so forth). Hard magnetic materials can be exemplified by Al—Ni—Co magnets, ferrite-type magnets, samarium cobalt magnets, neodymium-iron-boron magnets (NdFeB-type magnets), samarium-iron-nitrogen magnets, Fe—Pt alloy magnets, Fe—Co alloy magnets, Fe—Pd alloy magnets, and Co—Pd alloy magnets. NdFeB-type magnets are an example of a preferred hard magnetic material.

The preferred content of the magnet in the air electrode will vary as a function, inter alia, of the magnetic properties of the magnet used and the proportions of the other materials constituting the air electrode layer and for this reason may be particularly established as appropriate. Viewed from the perspective of improving the discharge capacity and discharge voltage, the proportion of the magnet in the air electrode layer, for example, is preferably from at least 10% by weight to less than 80% by weight, particularly preferably from at least 10% by weight to not more than 60% by weight, and even more preferably from at least 10% by weight to not more than 40% by weight. When a NdFeB-type magnet is used as the magnet, the proportion of the NdFeB-type magnet in the air electrode layer is preferably from at least 10% by weight to not more than 60% by weight and particularly preferably is from at least 20% by weight to not more than 40% by weight.

The electroconductive material is a material that exhibits electroconductivity but is not otherwise particularly limited, and can be exemplified by electroconductive carbon materials. While these electroconductive carbon materials are not particularly limited, carbon materials having a high specific surface area are preferred from the standpoint of the space or area of the reaction field where the metal oxide or metal hydroxide is produced. In specific terms, an electroconductive carbon material having a specific surface area of at least 10 m²/g, particularly at least 100 m²/g, and more particularly at least 600 m²/g is preferred. Carbon black, active carbon, and carbon fiber (for example, carbon nanotubes and carbon nanofibers) are specific examples of electroconductive carbon materials that have high specific surface areas. The specific surface area of the electroconductive material can be measured by, for example, the BET method.

The content of the electroconductive material in the air electrode layer will also vary as a function of, e.g., the density and specific surface area of the electroconductive material, but, for example, is preferably 10% by weight to 90% by weight. Viewed from the perspectives of the electroconductivity of the air electrode and maintenance of the reaction field in the air electrode, preferably a suitable quantity is incorporated as appropriate depending on the incorporation ratio (amount of incorporation) of the magnet or magnet material.

Based on a consideration of the immobilization of the magnet and/or electroconductive material, the air electrode layer preferably further incorporates a binder. This binder can be exemplified by polyvinylidene fluoride (PVDF), polytetrafluoroethylene (PTFE), and styrene-butadiene rubber (SBR). The content of the binder in the air electrode layer is, for example, preferably 5 to 50% by weight and particularly preferably 10 to 30% by weight. Easy molding of the air electrode layer is achieved when the binder content is 5% by weight or more. On the other hand, keeping the binder content to 50% by weight or less makes it possible to avoid a constriction of the reaction field in the air electrode and to bring about an efficient development of the desired reaction.

In addition to the previously described magnet, the air electrode layer may also contain an air electrode catalyst—other than the aforementioned magnet—that promotes the reactions of oxygen at the air electrode. This air electrode catalyst may be supported on the previously described electroconductive material. There are no particular limitations on the air electrode catalyst, and this air electrode catalyst can be exemplified by phthalocyanine compounds such as cobalt phthalocyanine, manganese phthalocyanine, nickel phthalocyanine, tin phthalocyanine oxide, titanium phthalocyanine, and dilithium phthalocyanine; naphthocyanine compounds such as cobalt naphthocyanine; porphyrin compounds such as iron porphyrin; metal oxides such as MnO₂, CeO₂, Co₃O₄, NiO, V₂O₅, Fe₂O₃, ZnO, CuO, LiMnO₂, Li₂MnO₃, LiMn₂O₄, Li₄Ti₅O₁₂, Li₂TiO₃, LiNi_{1/3}CO_{1/3}Mn_{1/3}O₂, LiNiO₂, LiVO₃, Li₅FeO₄, LiFeO₂, LiCrO₂, LiCoO₂, LiCuO₂, LiZnO₂, Li₂MoO₄, LiNbO₃, LiTaO₃, Li₂WO₄, Li₂ZrO₃, NaMnO₂, CaMnO₃, CaFeO₃, MgTiO₃, and KMnO₂; and composites of the preceding. The content in the air electrode layer of the air electrode catalyst other than the magnet is, for example, preferably from 1% by weight to 50% by weight.

The thickness of the air electrode layer will vary as a function of, inter alia, the application for the air battery, but, for example, is preferably in the range from 2 μm to 500 μm and particularly from 5 μm to 300 μm.

In addition to the air electrode layer, the air electrode may also be provided with an air electrode current collector that carries out current collection for the air electrode layer. The air electrode current collector should have the desired electronic conductivity and may have a porous structure or a fine, dense structure, but preferably has a porous structure from the perspective of the air (oxygen) diffusivity. The porous structure can be exemplified by a mesh structure in which the constituent fibers exhibit a regular arrangement, a nonwoven fabric structure in which the constituent fibers are randomly arranged, and a three dimensional network structure having independent pores and/or interconnected pores. There are no particular limitations on the porosity of a current collector that has a porous structure, but a porosity, for example, in the range from 20 to 99% is preferred. When an air electrode current collector having a porous structure is used, the air electrode current collector may also be disposed in the interior of the air electrode layer, unlike FIG. 1, which shows the air electrode layer laminated with (adjacent to) the air electrode current collector. An improved current collection efficiency for the air electrode can be expected when the air electrode current collector is disposed in the interior of the air electrode layer.

The material of the air electrode current collector can be exemplified by metals, e.g., stainless steel, nickel, aluminum, iron, titanium, copper, and so forth; carbon materials, e.g., carbon fibers, carbon paper, and so forth; and ceramic materials having a high electronic conductivity, e.g., titanium nitride and so forth. A current collector that uses a carbon material exhibits a high corrosion resistance and as a result accrues the advantage—when a strongly basic metal oxide is produced at the air electrode by the discharge reaction—of inhibiting elution of the current collector and thereby making it possible to avoid the decline in battery characteristics caused by this elution. Carbon paper and metal mesh are examples of preferred specific air electrode current collectors. There are no particular limitations on the thickness of the air electrode current collector, but, for example, 10 μm to 1000 μm and particularly 20 to 400 μm are preferred. The battery case for the air battery, see below, may also be provided with the ability to function as a current collector for the air electrode.

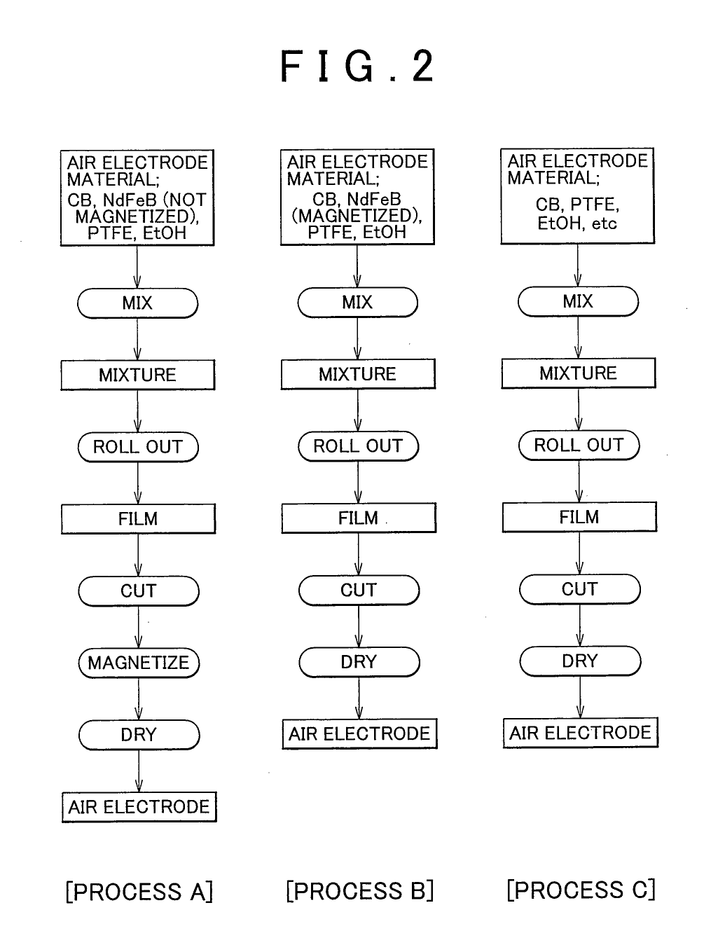

There are no particular limitations on the method of producing the air electrode. For example, as in process B in FIG. 2, the air electrode may be formed using an air electrode material provided by mixing a magnet that already exhibits magnetism with the other constituent materials of the air electrode, such as the electroconductive material, binder, and so forth. Or, as shown in process A in FIG. 2, the air electrode may be formed using an air electrode material provided by mixing a magnet material not exhibiting magnetism with the other constituent materials of the air electrode, such as the electroconductive material, binder, and so forth, and subjecting this air electrode material—or a molding provided by molding this air electrode material—to a treatment that magnetizes the magnet material.

When a magnet is used as a starting material for the air electrode material, a magnet-containing air electrode can be formed by molding this air electrode material. Specifically, an air electrode in which an air electrode layer is laminated with an air electrode current collector can be fabricated by molding by rolling or coating a solvent-containing air electrode material on the surface of an air electrode current collector and as necessary performing a drying treatment, compression treatment, heat treatment, and so forth. Or, an air electrode in which an air electrode layer is laminated with an air electrode current collector can be fabricated by preparing an air electrode layer by molding by rolling or coating a solvent-containing air electrode material and as necessary performing a drying treatment, compression treatment, heat treatment, and so forth; then stacking an air electrode current collector thereon; and carrying out, e.g., compression and/or heating as appropriate. The solvent used in the air electrode material should be volatile but is not otherwise particularly limited and can be selected as appropriate. Specific examples are acetone, N,N-dimethylformamide (DMF), and N-methyl-2-pyrrolidone (NMP). A solvent with a boiling point of not more than 200° C. is preferred from the standpoint of ease of drying of the air electrode material. There are no particular limitations on the method for applying the air electrode material and a general method can be used, e.g., doctor blade, spraying, and so forth.

When a magnet material not exhibiting magnetism is used as a starting material for the air electrode material, the magnet-containing air electrode can be fabricated by executing a magnetization treatment on the air electrode material—or on an air electrode molding provided by molding the air electrode material—to effect magnetization of the magnet material not exhibiting magnetism. The method of executing the magnetization treatment on an air electrode molding provided by molding the air electrode material offers the advantage of ease of adjustment of the conditions in the magnetization treatment. The magnet material can be exemplified by the materials provided above as examples of magnets, but residing in a nonmagnetic state. There are no particular limitations on the method for magnetizing the magnet material and conventional methods can be used. For example, magnetization can be performed by generating a magnetic field by passing current through a magnetizing coil or magnetizing yoke using a magnetization power source.

The method for forming an air electrode using an air electrode material that contains a magnet material is the same as for the use of a magnet-containing air electrode material as described above, with the exception that the former requires a magnetization treatment step in which the magnet material in the air electrode material is magnetized. There are no particular limitations on the timing of the magnetization treatment, and, for example, magnetization may be carried out, as described above, on the air electrode material or on an air electrode molding provided by molding the air electrode material. When the magnetization treatment is carried out on an air electrode molding, there is no particular limitation on the sequencing of the magnetization treatment and the other treatments carried out on the air electrode molding (for example, drying, cutting, and so forth).

The electrolyte will now be described. The electrolyte should be able to conduct the carrier ion between the air electrode and the negative electrode, but is not otherwise particularly limited, and it may be an electrolyte solution or a solid electrolyte. A nonaqueous electrolyte or an aqueous electrolyte can be used as the electrolyte solution.

The nonaqueous electrolyte contains a supporting electrolyte salt and a nonaqueous solvent. There are no particular limitations on the nonaqueous solvent and it can be exemplified by propylene carbonate (PC), ethylene carbonate (EC), vinylene carbonate, dimethyl carbonate (DMC), ethyl methyl carbonate (EMC), diethyl carbonate (DEC), methyl propyl carbonate, isopropyl methyl carbonate, ethyl propionate, methyl propionate, γ-butyrolactone, ethyl acetate, methyl acetate, tetrahydrofuran, 2-methyltetrahydrofuran, ethylene glycol dimethyl ether, ethylene glycol diethyl ether, acetonitrile (AcN), dimethyl sulfoxide (DMSO), diethoxyethane, dimethoxyethane (DME), and tetraethylene glycol dimethyl ether (TEGDME).

Ionic liquids may also be used as the nonaqueous solvent. Ionic liquids can be exemplified by aliphatic quaternary ammonium salts, e.g., N,N,N-trimethyl-N-propylammonium bis(trifluoromethanesulfonyl)amide (abbreviation: TMPA-TFSA), N-methyl-N-propylpiperidinium bis(trifluoromethanesulfonyl)amide (abbreviation: PP13-TFSA), N-methyl-N-propylpyrrolidinium bis(trifluoromethanesulfonyl)amide (abbreviation: P13-TFSA), N-methyl-N-butylpyrrolidinium bis(trifluoromethanesulfonyl)amide (abbreviation: P14-TFSA), and N,N-diethyl-N-methyl-N-(2-methoxyethyl)ammonium bis(trifluoromethanesulfonyl)amide (abbreviation: DEME-TFSA), and by alkylimidazolium quaternary salts, e.g., 1-methyl-3-ethylimidazolium tetrafluoroborate (abbreviation: EMIBF₄), 1-methyl-3-ethylimidazolium bis(trifluoromethanesulfonyl)amide (abbreviation: EMITFSA), 1-allyl-3-ethylimidazolium bromide (abbreviation: AEImBr), 1-allyl-3-ethylimidazolium tetrafluoroborate (abbreviation: AEImBF₄), 1-allyl-3-ethylimidazolium bis(trifluoromethanesulfonyl)amide (abbreviation: AEImTFSA), 1,3-diallylimidazolium bromide (abbreviation: AAImBr), 1,3-diallylimidazolium tetrafluoroborate (abbreviation: AAImBF₄), and 1,3-diallylimidazolium bis(trifluoromethanesulfonyl)amide (abbreviation: AAImTFSA).

The following are preferred for the nonaqueous solvent from the standpoint of electrochemical stability versus the oxygen radical: AcN, DMSO, PP13-TFSA, P13-TFSA, P14-TFSA, TMPA-TFSA, and DEME-TFSA.

The supporting electrolyte salt should be soluble in the nonaqueous solvent and should exhibit the desired metal ion conductivity. A metal salt containing the metal ion whose conduction is desired can generally be used. For example, a lithium salt can be used as the supporting electrolyte salt in the case of a lithium-air battery. The lithium salt can be exemplified by inorganic lithium salts such as LiPF₆, LiBF₄, LiClO₄, LiAsF₆, LiOH, LiCl, LiNO₃, and Li₂SO₄. Organolithium salts can also be used, e.g., CH₃CO₂Li, lithium bis(oxalato)borate (abbreviation: LiBOB), LiN(CF₃SO₂)₂ (abbreviation: LiTFSA), LiN(C₂F₅SO₂)₂ (abbreviation: LiBETA), and LiN(CF₃SO₂)(C₄F₉SO₂). The content in the nonaqueous electrolyte of the supporting electrolyte salt with reference to the nonaqueous solvent is not particularly limited, and, for example, the concentration of the lithium salt in the nonaqueous electrolyte is in the range, for example, of 0.5 mol/L to 3 mol/L.

The nonaqueous electrolyte may also be used gelled by the addition of a polymer. The method of gelling the nonaqueous electrolyte can be exemplified by the addition to the nonaqueous electrolyte of a polymer, e.g., polyethylene oxide (PEO), polyacrylonitrile (PAN), polyvinylidene fluoride (PVDF), or polymethyl methacrylate (PMMA).

The aqueous electrolyte contains a supporting electrolyte salt and water. The supporting electrolyte salt should be soluble in water and should exhibit the desired ionic conductivity but is not otherwise particularly limited. A metal salt containing the metal ion whose conduction is desired can generally be used. For example, in the case of a lithium-air battery, for example, a lithium salt such as LiOH, LiCl, LiNO₃, Li₂SO₄, or CH₃COOLi can be used.

The solid electrolyte can be exemplified by inorganic solid electrolytes. The inorganic solid electrolyte may be a glass, crystal, or glass ceramic. The specific inorganic solid electrolyte may be selected as appropriate in conformity with the carrier metal ion. For example, in the case of lithium-air batteries, the NASICON oxides can be exemplified by oxides given by, for example, LiₐX_{b}Y_{c}P_{d}Oₑ (X is at least one selection from the group consisting of B, Al, Ga, In, C, Si, Ge, Sn, Sb, and Se; Y is at least one selection from the group consisting of Ti, Zr, Ge, In, Ga, Sn, and Al; and a to e satisfy the following relationships: 0.5<a<5.0, 0≦b<2.98, 0.5≦c<3.0, 0.02<d≦3.0, 2.0<b+d<4.0, and 3.0<e≦12.0). Oxides with the preceding formula in which X═Al and Y═Ti (Li—Al—Ti—P—O type NASICON oxides) and oxides with the preceding formula in which X═Al and Y═Ge or X═Ge and Y═Al (Li—Al—Ge—Ti—O type NASICON oxides) are particularly preferred. In addition, the perovskite oxides can be exemplified by oxides given by LiₓLa₁₋ₓTiO₃ (Li—La—Ti—O type perovskite oxides).

Also in the case of lithium-air batteries, the LISICON oxides can be exemplified by Li₄XO₄—Li₃YO₄ (X is at least one selection from Si, Ge, and Ti and Y is at least one selection from P, As, and V), Li₄XO₄—Li₂AO₄ (X is at least one selection from Si, Ge, and Ti and A is at least one selection from Mo and S), Li₄XO₄—Li₂ZO₂ (X is at least one selection from Si, Ge, and Ti and Z is at least one selection from Al, Ga, and Cr), Li₄XO₄—Li₂BXO₄ (X is at least one selection from Si, Ge, and Ti and B is at least one selection from Ca and Zn), and Li₃DO₃—Li₃YO₄ (D is B and Y is at least one selection from P, As, and V). Li₄SiO₄—Li₃PO₄ and Li₃BO₃—Li₃PO₄ are particularly preferred.

Also in the case of lithium-air batteries, the garnet-type oxides can be exemplified by oxides given by, for example, Li₃₊ₓA_{y}G_{z}M₂₋ᵥBᵥO₁₂. Here, A, G, M, and B are metal cations. A is preferably an alkaline-earth metal cation, e.g., Ca, Sr, Ba, or Mg, or is preferably a transition metal cation such as Zn. G is preferably a transition metal cation such as La, Y, Pr, Nd, Sm, Lu, or Eu. M can be exemplified by transition metal cations such as Zr, Nb, Ta, Bi, Te, and Sb whereamong Zr is preferred. B is preferably, for example, In. x preferably satisfies 0≦x≦5 and more preferably satisfies 4≦x≦5. y preferably satisfies 0≦y≦3 and more preferably satisfies 0≦y≦2. z preferably satisfies 0≦z≦3 and more preferably satisfies 1≦z≦3. v preferably satisfies 0≦v≦2 and more preferably satisfies 0≦v≦1. The O may be partially or completely replaced by a divalent anion and/or a trivalent anion, for example, N³⁻. Li—La—Zr—O type oxides such as Li₇La₃Zr₂O₁₂ are preferred for the garnet-type oxide.

The negative electrode will now be described. The negative electrode is provided with a negative electrode layer that contains a negative electrode active material capable of releasing and incorporating the carrier ion species. In addition to the negative electrode layer, the negative electrode may be provided with a negative electrode current collector that performs current collection for the negative electrode layer. The negative electrode active material should be capable of releasing and incorporating the carrier ion species, which is typically a metal ion, but is not otherwise particularly limited, and can be exemplified by single metals, alloys, metal oxides, metal sulfides, and metal nitrides, in each case that contain the metal ion that is the carrier ion species. A carbon material may also be used as the negative electrode active material. Single metals and alloys are preferred for the negative electrode active material and single metals are particularly preferred. Single metals usable for the negative electrode active material can be exemplified by lithium, sodium, potassium, magnesium, calcium, aluminum, and zinc. The alloys can be exemplified by alloys that contain at least one of the aforementioned single metals. The negative electrode active material for a lithium-air battery can be more specifically exemplified by lithium metal; lithium alloys such as lithium-aluminum alloys, lithium-tin alloys, lithium-lead alloys, and lithium-silicon alloys; metal oxides such as tin oxide, silicon oxide, lithium titanium oxide, niobium oxide, and tungsten oxide; metal sulfides such as tin sulfide and titanium sulfide; metal nitrides such as lithium cobalt nitride, lithium iron nitride, and lithium manganese nitride; and carbon materials such as graphite, whereamong lithium metal and carbon materials are preferred and lithium metal is more preferred from the standpoint of achieving higher capacities.

The negative electrode layer should contain at least a negative electrode active material and may optionally contain a binder that immobilizes or fixes the negative electrode active material. For example, when an alloy or metal foil is used as the negative electrode active material, the negative electrode layer can assume a configuration in which it contains only the negative electrode active material. When a powder-form negative electrode active material is used, the negative electrode layer can assume a configuration in which it contains the negative electrode active material and a binder. The negative electrode layer may also contain an electroconductive material. With regard to this binder and electroconductive material, the type, amount of use, and so forth are the same as for the previously described air electrode and their description here is therefore omitted.

The material of the negative electrode current collector should be electroconductive but is not otherwise particularly limited. This material can be exemplified by copper, stainless steel, and nickel. The shape of the negative electrode current collector can be exemplified by foil, plate or sheet, and mesh. The battery case may also function as a negative electrode current collector.

There are no particular limitations on the method of producing the negative electrode. For example, a method may be used in which the negative electrode current collector is stacked on a negative electrode active material foil and pressure is then applied. In an example of another method, a negative electrode material mixture containing the negative electrode active material and binder is prepared; this mixture is coated on a negative electrode current collector; and drying is carried out.

An air battery typically has a battery case that holds the air electrode, negative electrode, and electrolyte layer. The shape of the battery case is not particularly limited and can be specifically exemplified by coin shape, disk shape, cylindrical, laminate, and so forth. The battery case may be open to the atmosphere or may be sealed. A battery case that is open to the atmosphere has a structure in which at least the air electrode layer can be brought into good contact with the atmosphere. On the other hand, a sealed battery case can be provided with an inlet tube for oxygen (air), which is the positive electrode active material, and with an exhaust tube. The introduced oxygen concentration is preferably high and pure oxygen is particularly preferred. When the air battery assumes a structure in which a laminate—in which the air electrode, electrolyte, and negative electrode are disposed in the indicated sequence—is repeatedly stacked for some number of times, based on safety considerations a separator is preferably present between the air electrode and negative electrode that belong to different laminates. This separator can be exemplified by porous films of, e.g., polyethylene or polypropylene, and by nonwoven fabrics, e.g., resin nonwoven fabrics and glass fiber nonwoven fabrics. When an electrolyte solution is used for the electrolyte, these materials usable for the separator may also be used as a supporting material in which the electrolyte solution is impregnated.

The air electrode current collector and the negative electrode current collector can both be provided with a terminal that will form the connection feature with the outside. The method of producing the air battery of this embodiment is not particularly limited and the usual methods can be used. Examples are described below.

### Example 1

First, the air electrode of Example 1 was fabricated using the process B shown in FIG. 2. Thus, a mixture was prepared by mixing carbon black (also referred to as “CB” below, product name: Super P from TIMCAL, specific surface area=60 m²/g), already magnetized NdFeB, PTFE, and ethanol (EtOH) so as to provide CB:NdFeB:PTFE=80:10:10 (weight ratio). This mixture was then rolled out using a twin roller to fabricate a film. The obtained film was cut and then dried at 120° C. to obtain an air electrode. The resulting air electrode was then used to fabricate a metal-air battery as shown in FIG. 1. Thus, an air electrode current collector (SUS304 mesh), the air electrode, a separator (polypropylene nonwoven fabric), a negative electrode (lithium metal), and a negative electrode current collector (SUS304 mesh) were stacked in the indicated sequence; an electrolyte solution (LiTFSA dissolved at 0.32 mol/kg in PP13-TFSA) was impregnated in the separator in order to have the electrolyte solution interposed between the air electrode and the negative electrode.

### Example 2

A metal-air battery was fabricated proceeding as in Example 1, but in this case producing the mixture by mixing the carbon black, already magnetized NdFeB, and PTFE so as to provide CB:NdFeB:PTFE=50:40:10 (weight ratio).

### Example 3

First, the air electrode of Example 3 was fabricated according to the process A shown in FIG. 2. Thus, a mixture was prepared by mixing carbon black (product name: Super P from TIMCAL, specific surface area=60 m²/g), NdFeB prior to magnetization (unmagnetized), PTFE, and ethanol so as to provide CB:NdFeB:PTFE=70:20:10 (weight ratio). This mixture was then rolled out using a twin roller to fabricate a film. The obtained film was cut followed by magnetization and drying at 120° C. to obtain an air electrode. The fabricated air electrode was then used to fabricate a metal-air battery proceeding as in Example 1.

### Example 4

A metal-air battery was fabricated proceeding as in Example 3, but in this case producing the mixture by mixing the carbon black, unmagnetized NdFeB, and PTFE so as to provide CB:NdFeB:PTFE=50:40:10 (weight ratio).

### Example 5

A metal-air battery was fabricated proceeding as in Example 3, but in this case producing the mixture by mixing the carbon black, unmagnetized NdFeB, and PTFE so as to provide CB:NdFeB:PTFE=30:60:10 (weight ratio).

### Example 6

First, the air electrode of Example 6 was fabricated according to the process C shown in FIG. 2. Thus, a mixture was prepared by mixing carbon black (also referred to as “CB” below, product name: Super P from TIMCAL, specific surface area=60 m²/g), already magnetized Fe₂O₃, PTFE, and ethanol (EtOH) so as to provide CB:Fe₂O₃:PTFE=50:40:10 (weight ratio). This mixture was then rolled out using a twin roller to fabricate a film. The obtained film was cut and then dried at 120° C. to obtain an air electrode. The fabricated air electrode was then used to fabricate a metal-air battery proceeding as in Example 1.

### Comparative Example 1

A metal-air battery was fabricated proceeding as in Example 6, but in this case without using the Fe₂O₃ and producing the mixture by mixing the carbon black and PTFE so as to provide CB:PTFE=90:10 (weight ratio).

### Comparative Example 2

A metal-air battery was fabricated proceeding as in Example 6, but in this case producing the mixture by mixing carbon black, MnO₂ (air electrode catalyst), and PTFE so as to provide CB:MnO₂:PTFE=80:10:10 (weight ratio).

### Comparative Example 3

A metal-air battery was fabricated proceeding as in Example 6, but in this case producing the mixture by mixing carbon black, La_{0.6}Sr_{0.4}CoO₃ (air electrode catalyst), and PTFE so as to provide CB:La_{0.6}Sr_{0.4}CoO₃:PTFE=80:10:10 (weight ratio).

### Comparative Example 4

A metal-air battery was fabricated proceeding as in Example 6, but in this case producing the mixture by mixing carbon black, Ag (air electrode catalyst), and PTFE so as to provide CB:Ag:PTFE=80:10:10 (weight ratio).

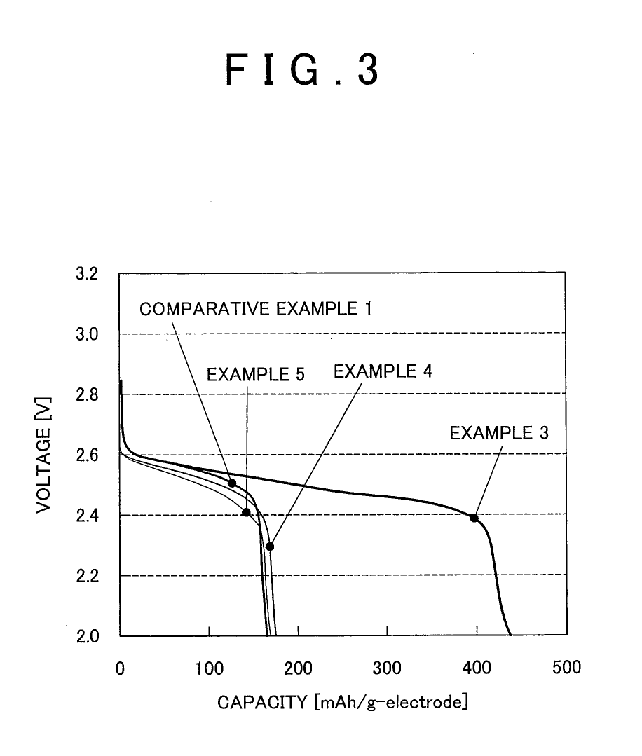

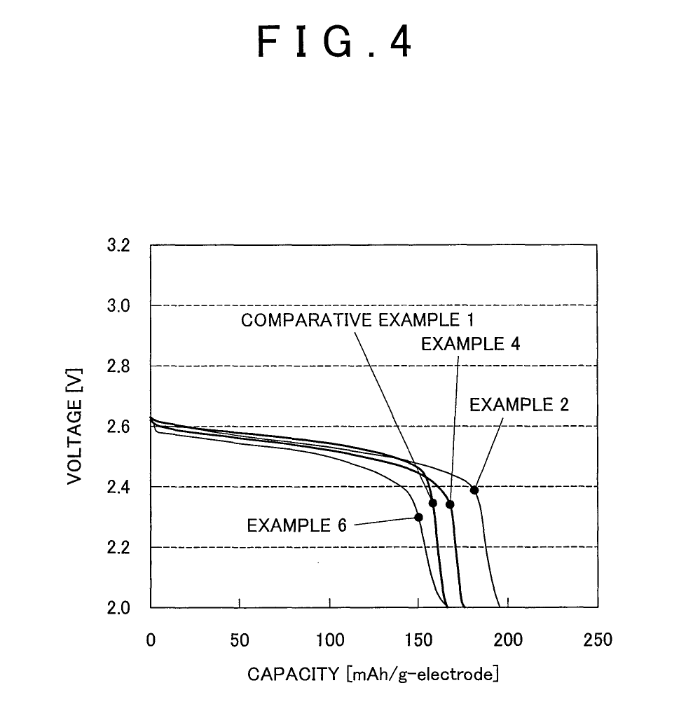

Constant-current charge-discharge measurements were carried out on the metal-air batteries of Examples 1 to 6 and Comparative Examples 1 to 4 at 0.02 mA/cm² and 60° C. under an oxygen atmosphere (99.9% pure oxygen). The results are shown in Table 1. In addition, FIGS. 3 and 4 show the discharge capacity-versus-voltage curves for Examples 2 to 6 and Comparative Example 1.

TABLE 1

| | | | initial |
|---|---|---|---|
| | | | discharge |
| | | | capacity |
| | | | (mAh/g- |
| | air electrode material | process | electrode) |
| Example 1 | CB(80):NdFeB(10):PTFE(10) | B | 152 |
| Example 2 | CB(50):NdFeB(40):PTFE(10) | B | 195 |
| Example 3 | CB(70):NdFeB(20):PTFE(10) | A | 437 |
| Example 4 | CB(50):NdFeB(40):PTFE(10) | A | 175 |
| Example 5 | CB(30):NdFeB(60):PTFE(10) | A | 169 |
| Example 6 | CB(50):Fe₂O₃(40):PTFE(10) | C | 166 |
| Comparative | CB(90):PTFE(10) | C | 166 |
| Example 1 | | | |
| Comparative | CB(80):MnO₂(10):PTFE(10) | C | 134 |
| Example 2 | | | |
| Comparative | CB(80):La_{0.6}Sr_{0.4}CoO₃(10):PTFE(10) | C | 145 |
| Example 3 | | | |
| Comparative | CB(80):Ag(10):PTFE(10) | C | 146 |
| Example 4 | | | |

As shown in Table 1, the metal-air batteries of Examples 1 to 6, which were provided with an air electrode according to this embodiment, exhibit a high discharge capacity and a high discharge voltage and high energy densities could thus be obtained. In particular, unusually high discharge capacities were seen in Examples 2 to 5, particularly in Examples 2 to 4, and more particularly in Example 3.

1. An air electrode for a metal-air battery, comprising a magnet, wherein
the air electrode constitutes the metal-air battery that is provided with the air electrode, a negative electrode, and an electrolyte interposed between the air electrode and the negative electrode.

2. The air electrode according to claim 1, wherein the magnet is a hard magnetic material.

3. The air electrode according to claim 2, wherein the hard magnetic material is a NdFeB-type magnet.

4. The air electrode according to claim 3, wherein the air electrode contains from at least 10% by weight to not more than 60% by weight of the NdFeB-type magnet.

5. The air electrode according to claim 4, wherein the air electrode contains from at least 20% by weight to not more than 40% by weight of the NdFeB-type magnet.

6. A metal-air battery comprising:
an air electrode;
a negative electrode; and
an electrolyte interposed between the air electrode and the negative electrode, wherein
the air electrode is the air electrode according to claim 1.

7. A method of producing an air electrode constituting a metal-air battery
the method comprising
performing a magnetization treatment on an air electrode molding provided by molding an air electrode material that contains at least a magnet material,
wherein the metal-air battery is provided with the air electrode, a negative electrode, and an electrolyte interposed between the air electrode and the negative electrode.

8. The metal-air battery according to claim 6, wherein the magnet is a hard magnetic material.

9. The metal-air battery according to claim 8, wherein the hard magnetic material is a NdFeB-type magnet.

10. The metal-air battery according to claim 9, wherein the air electrode contains form at least 10% by weight to not more than 60% by weight of the NdFeB-type magnet.

11. The metal-air battery according to claim 10, wherein the air electrode contains from at least 20% by weight to not more than 40% by weight of the NdFeB-type magnet.
